(19) United States
(12) Patent Application Publication
(10) Pub. No.: US 2004/0064691 A1
(43) Pub. Date: Apr. 1, 2004

(54) Method and system for processing certificate revocation lists in an authorization system

(75) Inventors: Ming Lu, Austin, TX (US); Ivan Matthew Milman, Austin, TX (US)

Correspondence Address: Joseph R. Burwell, Law Office of Joseph R. Burwell, P.O. Box 28022, Austin, TX, 78755-8022, US

(73) Assignee: INTERNATIONAL BUSINESS MACHINES CORPORATION, ARMONK, NY (US)

(21) Appl. No.: 10/256,096

(22) Filed: Sep. 26, 2002

(51) Int. Cl. H04L 9/00

(52) U.S. Cl. 713/158

(57) ABSTRACT

A method, system, apparatus, and computer program product are presented for processing certificate revocation lists (CRLs) in a data processing system. Rather than using CRLs for authentication purposes, CRLs are used for authorization purposes, and the responsibility of processing CRLs is placed on a monitoring process within a centralized authorization subsystem rather than the applications that authenticate certificates. A monitoring process obtain newly published CRLs and determines whether revoked certificates are associated with users that possess authorized privileges. If so, then the monitoring process updates one or more authorization databases to reduce or eliminate the authorized privileges for those users.

### BACKGROUND OF THE INVENTION

1. Field of the Invention

The present invention relates to an improved data processing system and, in particular, to a method and apparatus for multicomputer data transferring. Still more particularly, the present invention provides a method and apparatus for computer-to-computer authorization. More particularly, the present invention relates to authentication of users in a heterogeneous network.

2. Description of Related Art

Concerns about the integrity and privacy of electronic communication have grown with adoption of Internet-based services. Various encryption and authentication technologies have been developed to protect electronic communication, such as asymmetric encryption keys.

The X.509 set of standards for digital certificates has been promulgated to create a common, secure, computational framework that incorporates the use of cryptographic keys. An X.509 digital certificate is an International Telecommunications Union (ITU) standard that has been adopted by the Internet Engineering Task Force (IETF) body. It cryptographically binds the certificate holder, presumably the subject name within the certificate, with its public cryptographic key. This cryptographic binding is based on the involvement of a trusted entity within the Internet Public Key Infrastructure for X.509 certificates (PKIX) called the certifying authority (CA). As a result, a strong and trusted association between the certificate holder and its public key can become public information yet remain tamper-proof and reliable. An important aspect of this reliability is a digital signature that the certifying authority stamps on a certificate before it is released for use. Subsequently, whenever the certificate is presented to a system for use of a service, its signature is verified before the subject holder is authenticated. After the authentication process is successfully completed, the certificate holder may be provided access to certain information, services, or other controlled resources, i.e. the certificate holder may be authorized to access certain systems.

PKIX essentially creates and manages two different but closely related constructs: an X.509 certificate and an X.509 Certificate Revocation List (CRL). As noted above, a digital certificate provides an assurance, i.e. a certification, for a public key of the subject holding the certificate, whereas a CRL is the means by which a certifying authority announces the dissolution of the binding represented in a certificate. In other words, a CRL is the means by which the certifying authority declares that a previously issued yet unexpired certificate is no longer valid. Certificates are revoked for a variety of administrative reasons, such as a change in the subject's affiliation with an organization, or security reasons, such as when the security of the certificate or an associated key has been compromised in some manner, such as loss, theft, or unauthorized disclosure of the private key. Certificates that have been revoked are permanently invalidated; they cannot be unrevoked, resumed, reinstated, or otherwise reactivated. An issuing authority certifies a holder's public key by cryptographically signing the certificate data structure. Similarly, the revocation process is also certified by stamping the certifying authority's signature in the CRL data structure.

In order to properly validate a digital certificate, an application must check whether the certificate has been revoked. When the certifying authority issues the certificate, the certifying authority generates a unique serial number by which the certificate is to be identified, and this serial number is stored within the “Serial Number” field within an X.509 certificate. Typically, a revoked X.509 certificate is identified within a CRL via the certificate's serial number; a revoked certificate's serial number appears within a list of serial numbers within the CRL. Hence, an application that is validating a certificate must examine any certificate revocation lists that are potentially relevant to the certificate in order to determine whether the certificate has been revoked. In particular, any CRLs that have been recently published by the certificate authority that issued the certificate must be examined.

A certificate authority typically publishes a new CRL whenever a certificate is revoked. CRLs can be distributed to certificate-validating systems through a variety of mechanisms, but due to potential problems with pushing information to subscriber systems, commercial PKIX systems usually rely on a polling mechanism in which a certificate-validating application has the responsibility of polling for CRLs. The certificate authority can put newly published CRLs into particular locations, such as an LDAP (Lightweight Directory Access Protocol) directory, and this particular location is specified in the certificates that are issued by a certificate authority.

Checking CRLs for each certificate that is being processed by each certificate-using application has a huge performance impact on networks and servers. Polling for CRLs from many application servers can create undesirable network traffic, and some servers within an enterprise network may not have direct access to CRL storage locations due to firewall policies. Lengthening a polling interval reduces network traffic but increases security risks, while shortening the polling interval degrades network and system performance. In lieu of or in addition to checking a CRL, the Online Certificate Status Protocol (OCSP) requires each certificate-using application to contact a server to get the status of a certificate, e.g., current, expired, or unknown. These OCSP status checks also put computational burdens on certificate-using applications and create network traffic.

Therefore, it would be advantageous to have a method and system that minimizes the computational burden that is caused by examining CRLs.

### SUMMARY OF THE INVENTION

A method, system, apparatus, and computer program product are presented for processing certificate revocation lists (CRLs) in a data processing system. Rather than using CRLs for authentication purposes, CRLs are used for authorization purposes, and the responsibility of processing CRLs is placed on a monitoring process within a centralized authorization subsystem rather than the applications that authenticate certificates. A monitoring process obtain newly published CRLs and determines whether revoked certificates are associated with users that possess authorized privileges. If so, then the monitoring process updates one or more authorization databases to reduce or eliminate the authorized privileges for those users.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical distributed data processing system in which the present invention may be implemented;

FIG. 1B depicts a typical computer architecture that may be used within a data processing system in which the present invention may be implemented;

FIG. 2 depicts a typical manner in which an entity obtains a digital certificate;

FIG. 3 is a block diagram depicting a typical manner in which an entity may use a digital certificate with an Internet system or application;

FIG. 4A shows some of the fields of a standard X.509 digital certificate;

FIG. 4B show some of the fields of an X.509 certificate revocation list;

FIG. 5A is a block diagram that depicts a manner in which a certificate revocation list may be used during an authentication operation within a distributed data processing system that comprises a centralized authorization system or subsystem;

FIG. 5B is a block diagram that depicts a manner in which a certificate revocation list may be used by a monitoring process for modifying authorization privileges within a distributed data processing system that comprises a centralized authorization system or subsystem; and

FIG. 6 is a flowchart that depicts a monitoring process by which a centralized authorization subsystem updates authorization privileges for users whose certificates are indicated as being revoked in accordance with newly published certificate revocation lists.

### DETAILED DESCRIPTION OF THE INVENTION

In general, the devices that may comprise or relate to the present invention include a wide variety of data processing technology. Therefore, as background, a typical organization of hardware and software components within a distributed data processing system is described prior to describing the present invention in more detail.

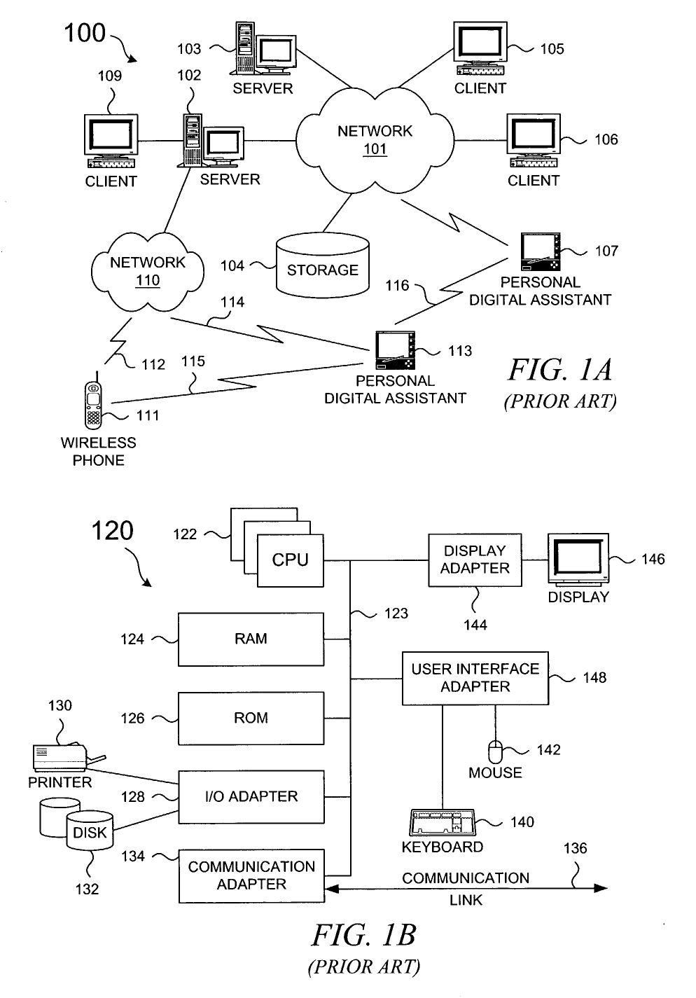

With reference now to the figures, FIG. 1A depicts a typical network of data processing systems, each of which may implement a portion of the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 107 via wireless communication link 116.

The present invention could be implemented on a variety of hardware platforms; FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as a audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. In other words, one of ordinary skill in the art would not expect to find identical components or architectures within a Web-enabled or network-enabled phone and a fully featured desktop workstation. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files.

The present invention may be implemented on a variety of hardware and software platforms, as described above. More specifically, though, the present invention is directed to providing authorization for secure user access to applications or systems within a distributed data processing environment. To accomplish this goal, the present invention uses the trusted relationships associated with digital certificates in a novel manner. Before describing the present invention in more detail, though, some background information about digital certificates is provided for evaluating the operational efficiencies and other advantages of the present invention.

Digital certificates support public key cryptography in which each party involved in a communication or transaction has a pair of keys, called the public key and the private key. Each party's public key is published while the private key is kept secret. Public keys are numbers associated with a particular entity and are intended to be known to everyone who needs to have trusted interactions with that entity. Private keys are numbers that are supposed to be known only to a particular entity, i.e. kept secret. In a typical public key cryptographic system, a private key corresponds to exactly one public key.

Within a public key cryptography system, since all communications involve only public keys and no private key is ever transmitted or shared, confidential messages can be generated using only public information and can be decrypted using only a private key that is in the sole possession of the intended recipient. Furthermore, public key cryptography can be used for authentication, i.e. digital signatures, as well as for privacy, i.e. encryption.

Encryption is the transformation of data into a form unreadable by anyone without a secret decryption key; encryption ensures privacy by keeping the content of the information hidden from anyone for whom it is not intended, even those who can see the encrypted data. Authentication is a process whereby the receiver of a digital message can be confident of the identity of the sender and/or the integrity of the message.

For example, when a sender encrypts a message, the public key of the receiver is used to transform the data within the original message into the contents of the encrypted message. A sender uses a public key of the intended recipient to encrypt data, and the receiver uses a private key to decrypt the encrypted message.

When authenticating data, data can be signed by computing a digital signature from the data and the private key of the signer. Once the data is digitally signed, it can be stored with the identity of the signer and the signature that proves that the data originated from the signer. A signer uses a private key to sign data, and a receiver uses the public key of the signer to verify the signature.

A certificate is a digital document that vouches for the identity and key ownership of entities, such as an individual, a computer system, a specific server running on that system, etc. Certificates are issued by certificate authorities. A certificate authority (CA) is an entity, usually a trusted third party to a transaction, that is trusted to sign or issue certificates for other people or entities. The CA usually has some kind of legal responsibilities for its vouching of the binding between a public key and its owner that allow one to trust the entity that signed a certificate. There are many such certificate authorities, such as VeriSign, Entrust, etc. These authorities are responsible for verifying the identity and key ownership of an entity when issuing the certificate.

If a certificate authority issues a certificate for an entity, the entity must provide a public key and some information about the entity. A software tool, such as specially equipped Web browsers, may digitally sign this information and send it to the certificate authority. The certificate authority might be a company like VeriSign that provides trusted third-party certificate authority services. The certificate authority will then generate the certificate and return it. The certificate may contain other information, such as dates during which the certificate is valid and a serial number. One part of the value provided by a certificate authority is to serve as a neutral and trusted introduction service, based in part on their verification requirements, which are openly published in their Certification Service Practices (CSP).

Typically, after the CA has received a request for a new digital certificate, which contains the requesting entity's public key, the CA signs the requesting entity's public key with the CA's private key and places the signed public key within the digital certificate. Anyone who receives the digital certificate during a transaction or communication can then use the public key of the CA to verify the signed public key within the certificate. The intention is that an entity's certificate verifies that the entity owns a particular public key.

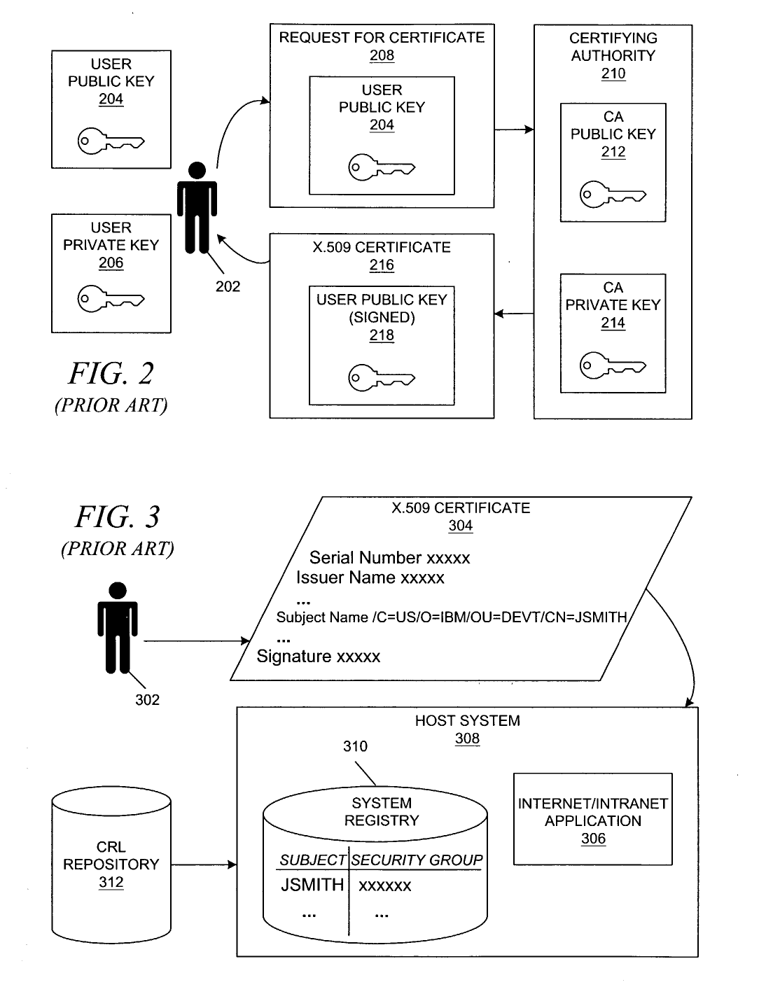

Other aspects of certificate processing are also standardized. The Certificate Request Message Format (RFC 2511) specifies a format that has been recommended for use whenever a relying party is requesting a certificate from a CA. Certificate Management Protocols have also been promulgated for transferring certificates. More information about the X.509 public key infrastructure (PKIX) can be obtained from the Internet Engineering Task Force (IETF) at www.ietf.org. The description of FIGS. 2-4B provides some useful background information about digital certificates because the present invention resides in a distributed data processing system that processes digital certificates and/or certificate revocation lists.

With reference now to FIG. 2, a block diagram depicts a typical manner in which an individual obtains a digital certificate. User 202, operating on some type of client computer, has previously obtained or generated a public/private key pair, e.g., user public key 204 and user private key 206. User 202 generates a request for certificate 208 containing user public key 204 and sends the request to certifying authority 210, which is in possession of CA public key 212 and CA private key 214. Certifying authority 210 verifies the identity of user 202 in some manner and generates X.509 digital certificate 216 containing signed user public key 218. The entire certificate is signed with CA private key 214; the certificate includes the public key of the user, the name associated with the user, and other attributes. User 202 receives newly generated digital certificate 216, and user 202 may then present digital certificate 216 as necessary to engage in trusted transactions or trusted communications. An entity that receives digital certificate 216 from user 202 may verify the signature of the CA by using CA public key 212, which is published and available to the verifying entity.

With reference now to FIG. 3, a block diagram depicts a typical manner in which an entity may use a digital certificate to be authenticated to an Internet system or application. User 302 possesses X.509 digital certificate 304, which is transmitted to an Internet or intranet application 306 on host system 308; application 306 comprises X.509 functionality for processing and using digital certificates. User 302 signs or encrypts data that it sends to application 306 with its private key.

The entity that receives certificate 304 may be an application, a system, a subsystem, etc. Certificate 304 contains a subject name or subject identifier that identifies user 302 to application 306, which may perform some type of service for user 302. The entity that uses certificate 304 verifies the authenticity of the certificate before using the certificate with respect to the signed or encrypted data from user 302.

Host system 308 may also contain system registry 310 which is used to authorize user 302 for accessing services and resources within system 308, i.e. to reconcile a user's identity with user privileges. For example, a system administrator may have configured a user's identity to belong to certain a security group, and the user is restricted to being able to access only those resources that are configured to be available to the security group as a whole. Various well-known methods for imposing an authorization scheme may be employed within the system.

As noted previously with respect to the prior art, in order to properly validate a digital certificate, an application must check whether the certificate has been revoked. When the certifying authority issues the certificate, the certifying authority generates a unique serial number by which the certificate is to be identified, and this serial number is stored within the “Serial Number” field within an X.509 certificate. Typically, a revoked X.509 certificate is identified within a CRL via the certificate's serial number; a revoked certificate's serial number appears within a list of serial numbers within the CRL.

In order to determine whether certificate 304 is still valid, application 306 obtains a certificate revocation list (CRL) from CRL repository 312 and validates the CRL. Application 306 compares the serial number within certificate 304 with the list of serial numbers within the retrieved CRL, and if there are no matching serial numbers, then application 306 validates certificate 304. If the CRL has a matching serial number, then certificate 304 should be rejected, and application 306 can take appropriate measures to reject the user's request for access to any controller resources.

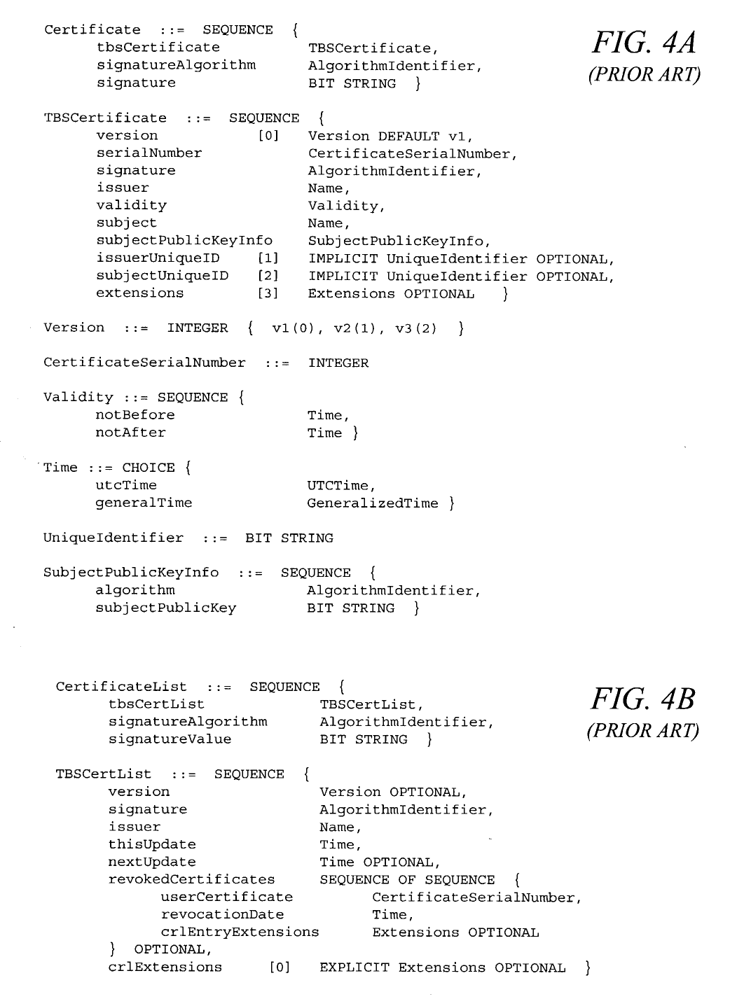

With reference now to FIG. 4A, some of the fields of a standard X.509 digital certificate are shown. The constructs shown in FIG. 4A are in Abstract Syntax Notation 1 (ASN.1) and are defined within the X.509 standard.

With reference now to FIG. 4B, some of the fields of an X.509 certificate revocation list are shown. Each revoked certificate is identified in a CRL using the construct shown in FIG. 4B, which is also in ASN.1 notation. Definitions for digital certificates and certificate revocation lists are specifically recited within “Internet X.509 Public Key Infrastructure Certificate and CRL Profile”, IETF RFC 2459, January 1999.

As described above, a certificate revocation list is a mechanism by which a certificate is decertified. In other words, a CRL represents a dissolved or repudiated relationship between a trusted third party and a set of subjects that are holding or presenting a certificate, i.e. a user. Hence, CRLs are typically used to determine whether or not a certificate is valid prior to performing some operation on behalf of a user. As shown in FIG. 3, a CRL is typically used during an authentication process while a certificate is being validated.

Turning now to the present invention, the description of the remaining figures is directed to an explanation of a novel technique. In contrast to typical prior art systems, the present invention processes certificate revocation lists for authorization purposes rather than authentication purposes. Relevant publications of certificate revocation lists are monitored in the present invention to determine whether a certificate for a user with authorized privileges has been revoked, and if so, the authorized privileges are curtailed or withdrawn.

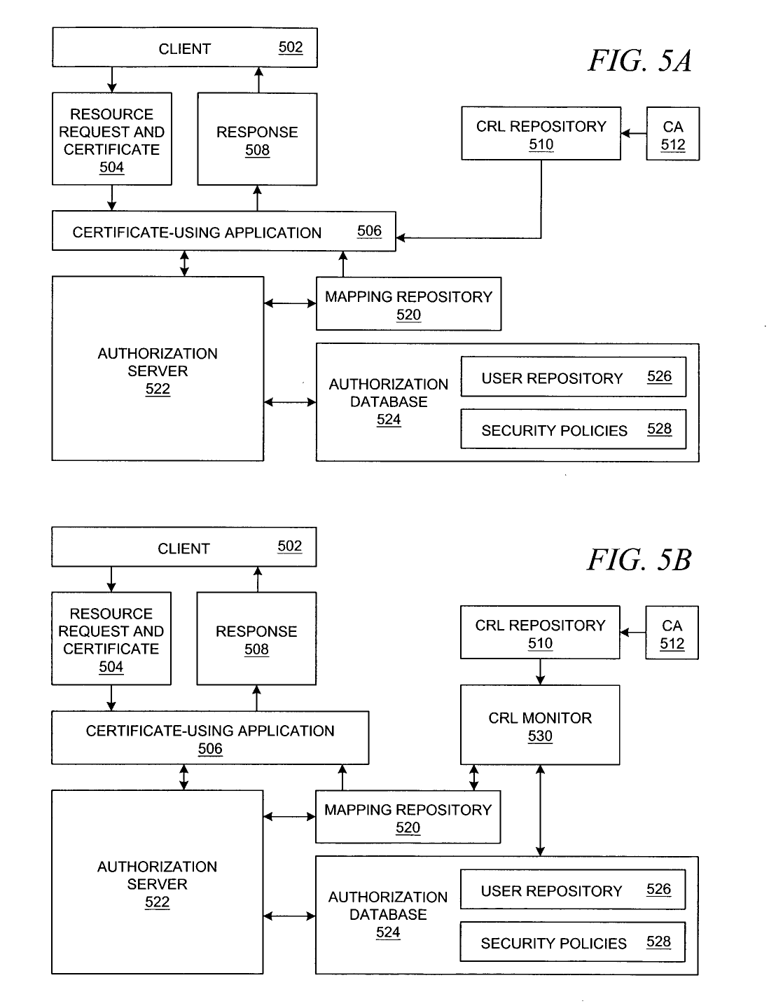

With respect to FIG. 5A, a block diagram depicts a manner in which a certificate revocation list may be used during an authentication operation within a distributed data processing system that comprises a centralized authorization system or subsystem. In a manner similar to that shown in FIG. 3, FIG. 5A depicts a system in which a CRL is processed during an authentication operation. More specifically, FIG. 5A shows that a CRL can be processed during a certificate validation operation for authentication purposes prior to invoking functionality within a centralized authorization subsystem or system for authorization purposes.

Client 502 sends a request for a controlled resource along with a digital certificate, shown as request/certificate 504, on behalf of a user who is operating client 502; client 502 also sends proof of possession of the private key by signing some data using the private key. Certificate-using application 506 receives the request/certificate and, at some later time, sends response 508, which may be positive or negative.

However, prior to sending a response, application 506 attempts to validate the received certificate in order to authenticate the identity of the user of client 502 and to determine whether the user should be provided with access to the requested resource. As previously described above, a certificate may have been revoked as indicated within a CRL. As part of the certificate validation operation, application 506 retrieves a CRL from CRL repository 510 into which certificate authority 512 has published one or more CRLs. If application 506 does not discover that the received certificate has been revoked, and if the certificate is otherwise validated, then the authentication operation is completed, and application 506 can proceed to determine whether the user is authorized to access the requested resource. The authorization determination is performed by an authorization framework or subsystem.

However, authorization subsystems are frequently operated in a distinct manner from authentication subsystems. It is possible for an enterprise to purchase an authentication framework and an authorization framework from different vendors and then integrate the two subsystems. In fact, an authorization framework may interface with multiple different types of authentication frameworks, each of which uses a different technique for authentication. For example, one authentication framework may rely upon digital certificates while another may rely upon biometric information. Moreover, each authentication framework may maintain its own set of user identities. In the case of digital certificates, a digital certificate contains the name of the user for which a certificate authority has issued the digital certificate. With respect to the terminology used with digital certificates, a user is considered a “subject”, and the identity of the user is stored within a certificate in a “distinguished name” field or a “subject” field, as shown in FIG. 4A. The distinguished name is then used as a user identifier with respect to authentication operations.

Rather than employing user identities from a particular authentication framework, the authorization framework can maintain a distinct set of user identities, which is particularly useful because the authorization framework may need to interface with multiple authentication frameworks, each of which maintains its own set of user identities. In order for the data processing system to use a user identity with respect to the authentication framework and a different user identity with respect to the authorization framework, a mechanism is provided for mapping one user identity in the authentication framework to another user identity in the authorization framework.

Referring again to FIG. 5A, application 506 maps the distinguished name within the received certificate to the authorization subsystem's internal user identifier in accordance with information within a mapping repository 520. A distinguished name for the user was set within a certificate when a certificate authority issued the certificate for the user; the authorization subsystem's internal user identifier was generated when the user was administratively approved, i.e. authorized, for certain privileges. The distinguished name is not identical to the user identifier within the authorization subsystem, thereby allowing the authorization subsystem and the authentication subsystem to operate with respect to different standards, principles, or rules as determined by different vendors.

After mapping the certificate's distinguished name to an authorization user identity that may be used by authorization server 522, application 506 can send an authorization request with the authorization user identity to authorization server 522, which uses authorization database 524 in its decision-making operation. Authorization server 522 checks user repository 526 to determine what security policies are applicable to the identified user, and then authorization server 522 obtains applicable security policies 528 in order to make a decision, which is returned to application 506. User repository 526 may be implemented as an LDAP (Lightweight Directory Access Protocol) directory, and security policies 528 may be implemented as access control lists (ACLs).

Although FIG. 5A shows a single application, it should be noted that a distributed data processing system may have many applications that are similar to application 506. Since authentication operations are performed by each application, the authentication operations can be considered to be distributed. In turn, each application relies on a authorization subsystem that operates in a centralized manner, although it should be noted that multiple authorization servers could be implemented in a distributed yet centralized manner. Hence, the authentication operations can be considered to be distributed while the authorization operations can be considered to be centralized.

With reference now to FIG. 5B, a block diagram depicts a manner in which a certificate revocation list may be used by a monitoring process for modifying authorization privileges within a distributed data processing system that comprises a centralized authorization system or subsystem. In a manner similar to that shown in FIG. 5A, FIG. 5B depicts a client that sends a request for a controlled resource along with a digital certificate on behalf of a user who is operating the client; similar elements in FIG. 5A and FIG. 5B have similar reference numerals. The data processing systems shown in FIG. 5A and FIG. 5B can both be considered to comprise distributed authentication operations and centralized authorization operations.

In contrast to the data processing system shown in FIG. 5A, though, the data processing system in FIG. 5B differs in that the operations with respect to the certificate revocation lists have been moved from the distributed authenticating entities to the centralized authorizing entity.

This implementation is based on a novel recognition of the relationship between the nature of a certificate revocation list and its utility within an enterprise network environment. As mentioned above, a digital certificate may be revoked, i.e. listed in a certificate revocation list, for a number of reasons. With respect to an enterprise that is providing access to controlled resources, the consequence of the fact that a certificate has been revoked should be the removal of authorized privileges for the user who is associated with the certificate. By moving the responsibility of processing CRLs to the centralized authorizing entity from the distributed authenticating entities, the network environment experiences better performance. Referring again to FIG. 5B, instead of application 506 polling for CRLs, monitor process 530 polls for any newly published CRLs in CRL repository 510. When a newly published CRL is found, monitor process 530 updates the authorization information for any users, i.e. distinguished names, that are found within a CRL.

Although application 506 is no longer responsible for checking CRLs, application 506 continues to send authorization requests to authorization server 522 as described with respect to FIG. 5A. If monitor process 530 has changed the authorization privileges for the user of client 502 in response to a newly published CRL that has revoked the user's certificate, then authorization server 522 will generate a negative authorization response, and application 506 will deny client 502 access to the requested resource.

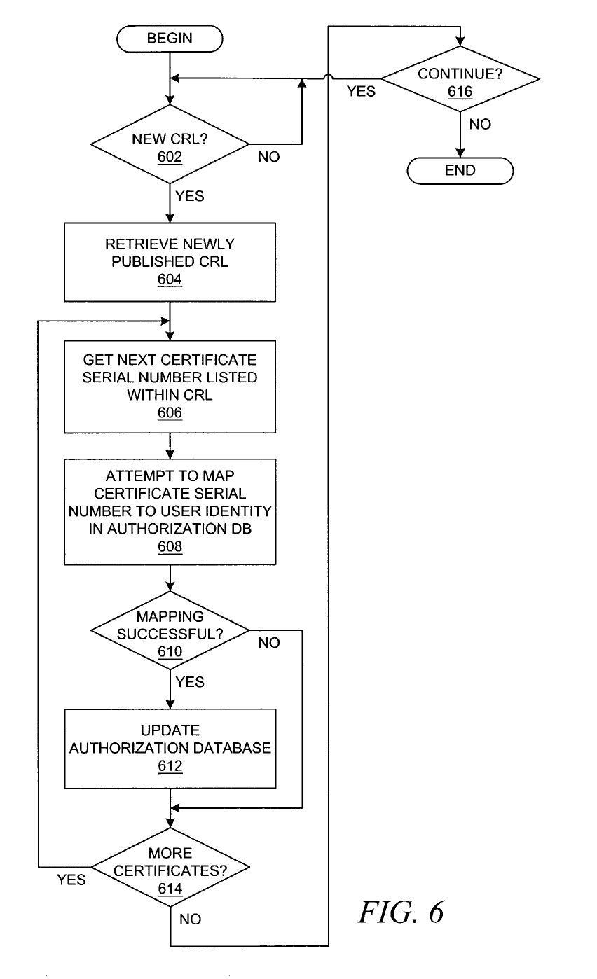

With reference now to FIG. 6, a flowchart depicts a monitoring process by which a centralized authorization subsystem updates authorization privileges for users whose certificates are indicated as being revoked in accordance with newly published certificate revocation lists. The process begins with a monitoring process that continually checks whether a certificate revocation list has been newly published (step 602). If not, then the monitor process continues to poll one or more CRL repositories for newly published CRLs. If there is a newly published CRL, then the monitor process retrieves it for processing (step 604).

It should be noted that other mechanisms for obtaining a CRL may be implemented by the monitoring process. For example, CRLs may be pushed to entities that have previously registered with some entity, such as a certificate authority, to receive newly published CRLs. In this case, the monitoring process would not be required to poll a CRL repository.

The monitor process then loops through all of the certificates that are listed in the CRL. The next certificate serial number in the CRL is retrieved (step 606), and an attempt is made to map the certificate serial number to a user identity using the information within the authorization subsystem's database (step 608). Whereas the descriptions of FIG. 5A and FIG. 5B discuss the use of a certificate's distinguished name in an authorization identity mapping operation rather than a certificate's serial number, as used in step 606, it should be noted that the authorization database may be populated with various data items from a user's digital certificate when a user is administratively approved, i.e. authorized, for certain privileges. Hence, the serial number for the certificate may also be stored in the authorization database along with the user's distinguished name, thereby allowing a lookup operation using the serial numbers in a certificate revocation list.

A determination is made whether the mapping operation is successful (step 610), and if so, then the authorization database is updated to modify the user's privileges (step 612); otherwise, the process merely branches because the serial number from the CRL is not associated with a user that has authorized privileges. Other security-related operations may also be performed if the authorization database is updated. For example, in some embodiments, certificate-using applications may cache authorization information; when the authorization database is updated, these applications would be notified to flush their caches because the caches would no longer contain current information.

A determination is then made whether there are more certificate serial numbers in the retrieved CRL that have not yet been processed (step 614), and if so, the process branches to step 606. If there are no more certificate serial numbers to be processed, then a determination is made whether to continue the monitoring process (step 616), and if so, then the process branches to step 602. Otherwise, the process is complete, e.g., the process may have been administratively terminated.

If the monitoring process is able to map a revoked certificate with a user who has authorized privileges as indicated within the authorization database, the monitor process can initiate a variety of different modifications to the authorization database that depend upon the implementation of the authorization subsystem. In one embodiment, the authorization database maintains a data item for each user that indicates membership in a authorized group or authorized class of users. When originally authorized for access, the user originally belongs to a certain authorized group or authorized class of users. If the user's certificate is revoked, then the user may subsequently be moved to another type of authorized group or authorized class of users by changing the value of the data item in the database for the user that is related to authorized group or authorized class. The subsequent authorized group or authorized class would likely have no privileges, although in some cases, there may be some groups or classes that have a very minimal set of privileges, and the user could be placed in one of these groups or classes. For example, many systems allow guest and/or temporary users, and the user could be placed in one of these groups that have guest-level privileges that allow a user to view certain types of information but do not allow a user to perform any substantial operations, thereby reducing the authorized privileges for the user. Referring again to FIG. 5B, modifying the group or class membership of a user could be done by updating the user repository, the security policies, or the mapping repository, as appropriate.

In another embodiment, the authorization database maintains an access control list (ACL) for each user that indicates the resources that a user is authorized to access. If a user's certificate is revoked, then the list of authorized resources would be deleted or eliminated. In some cases, as mentioned above, a minimal set of guest-level resources may remain in the ACL so that the user retains the ability to perform a minimal set of operations.

The advantages of the present invention should be apparent in view of the detailed description that is provided above. In the present invention, operations with respect to the certificate revocation lists are performed by a centralized authorizing entity rather than distributed authenticating entities. In so doing, security, scalability, and performance are improved. Security is improved because security changes, as promulgated through CRLs, quickly take effect. Since there is only one monitor process that is watching for the publication of CRLs, the polling interval can be set rather small so that CRLs are retrieved much more quickly. In addition, the monitor process updates the authorization database immediately such that the changes take effect on all certificate-using applications that the authorization subsystem supports.

Performance is improved because a large amount of network traffic is eliminated by the centralized monitor process, and each certificate-using application is not burdened with the responsibility of checking for CRLs and examining the CRLS. By removing the CRL checking operation from each certificate-using application, the system is much more scalable because only one monitor process is require no matter how many certificate-using applications are supported.

It is important to note that while the present invention has been described in the context of a fully functioning data processing system, those of ordinary skill in the art will appreciate that some of the processes associated with the present invention are capable of being distributed in the form of instructions or other means on a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

A method is generally conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for managing certificate revocation in a distributed computing environment, the method comprising:
centrally monitoring certificate revocation for a plurality of processes executing in the distributed computing environment; and
responsive to detecting revocation of a certificate, changing user authorization information pertaining to at least one of the plurality of processes.

2. The method of claim 1 further comprising:
polling a repository for a certificate revocation list in accordance with a predetermined polling interval.

3. The method of claim 1 further comprising:
performing the monitoring of certificate revocation within a centralized authorization subsystem.

4. The method of claim 1 further comprising:
obtaining a certificate revocation list;
for each certificate indicated as being revoked by the certificate revocation list, determining whether each certificate was issued to a user that is associated with a set of authorized privileges; and
in response to a determination that a certificate was issued to a user that is associated with a set of authorized privileges, updating a database to modify the set of authorized privileges for the user for which the certificate was issued.

5. The method of claim 4 further comprising:
reducing and/or eliminating the set of authorized privileges for the user when the database is updated.

6. The method of claim 4 further comprising:
modifying membership for the user for which the certificate was issued from a first authorization group to a second authorization group having lesser authorized privileges than the first group.

7. An apparatus for managing certificate revocation in a distributed computing environment, the apparatus comprising:
means for centrally monitoring certificate revocation for a plurality of processes executing in the distributed computing environment; and
means for changing user authorization information pertaining to at least one of the plurality of processes in response to detecting revocation of a certificate.

8. The apparatus of claim 7 further comprising:
means for polling a repository for a certificate revocation list in accordance with a predetermined polling interval.

9. The apparatus of claim 7 further comprising:
means for performing the monitoring of certificate revocation within a centralized authorization subsystem.

10. The apparatus of claim 7 further comprising:
means for obtaining a certificate revocation list;
means for determining, for each certificate indicated as being revoked by the certificate revocation list, whether each certificate was issued to a user that is associated with a set of authorized privileges; and
means for updating a database in response to a determination that a certificate was issued to a user that is associated with a set of authorized privileges in order to modify the set of authorized privileges for the user for which the certificate was issued.

11. The apparatus of claim 10 further comprising:
means for reducing and/or eliminating the set of authorized privileges for the user when the database is updated.

12. The apparatus of claim 10 further comprising:
means for modifying membership for the user for which the certificate was issued from a first authorization group to a second authorization group having lesser authorized privileges than the first group.

13. A computer program product in a computer readable medium for use in a distributed computing environment for managing certificate revocation, the computer program product comprising:
means for centrally monitoring certificate revocation for a plurality of processes executing in the distributed computing environment; and
means for changing user authorization information pertaining to at least one of the plurality of processes in response to detecting revocation of a certificate.

14. The computer program product of claim 13 further comprising:
means for polling a repository for a certificate revocation list in accordance with a predetermined polling interval.

15. The computer program product of claim 13 further comprising:
means for performing the monitoring of certificate revocation within a centralized authorization subsystem.

16. The computer program product of claim 13 further comprising:
means for obtaining a certificate revocation list;
means for determining, for each certificate indicated as being revoked by the certificate revocation list, whether each certificate was issued to a user that is associated with a set of authorized privileges; and
means for updating a database in response to a determination that a certificate was issued to a user that is associated with a set of authorized privileges in order to modify the set of authorized privileges for the user for which the certificate was issued.

17. The computer program product of claim 16 further comprising:
means for reducing and/or eliminating the set of authorized privileges for the user when the database is updated.

18. The computer program product of claim 16 further comprising:
means for modifying membership for the user for which the certificate was issued from a first authorization group to a second authorization group having lesser authorized privileges than the first group.
